(19) United States
(12) Patent Application Publication
(10) Pub. No.: US 2015/0321209 A1
(43) Pub. Date: Nov. 12, 2015

(54) LOTION CONTAINER DIP TUBE

(71) Applicants: Joseph Brickler, Lake Zurich, IL (US); Meagan Brickler, Lake Zurich, IL (US)

(72) Inventors: Joseph Brickler, Lake Zurich, IL (US); Meagan Brickler, Lake Zurich, IL (US)

(21) Appl. No.: 14/703,948

(22) Filed: May 5, 2015

Related U.S. Application Data
(60) Provisional application No. 61/988,934, filed on May 6, 2014.

(51) Int. Cl. B05B 15/00; A45D 34/00; B05B 11/00

(52) U.S. Cl. CPC B05B 15/005; B05B 11/3001; A45D 34/00

(57) ABSTRACT

A tool for removing the residual product from a lotion bottle having a pump mechanism. An extension to the dip tube allows the user to scoop the residual product from the bottle and avoid wasting same.

### CROSS-REFERENCE TO RELATED APPLICATION

This application claims benefit of U.S. Provisional Patent Application No. 61/988,934, filed on May 6, 2014, which is incorporated by reference in its entirety.

### BACKGROUND OF THE INVENTION

I. Field of the Invention.

The present disclosure relates generally to dip tubes for pump dispensers, and more specifically to a lotion container dip tube for removing any remaining product after the pump has exhausted its product dispensing capabilities.

II. Description of the Prior Art.

It is well known to obtain lotion, e.g. soap, skin lotion, shampoo, conditioner, cosmetic agents, cleaning agents, etc., from a container and/or bottle by hand squeezing the bottle/container. There also exists a variety of packages that utilize pump dispensers for the evacuation of such liquid/lotion contents within the packages. The pump dispenser is usually sealingly fitted to the mouth of the package, e.g. by a screw-on or snap-on cap. With each press of the pump head, a certain amount of the contents is pumped up.

Whether the contents of the container are squeezed out of the container by hand, or pumped out via a dispenser, there inevitably remains a certain amount of product that is not removed from the container and therefor wasted.

In an attempt to address this issue of wasted product, there have been a plethora of container, pump and dip tube designs and redesigns. Such concepts include, for example, modifying the shape of the bottom of the container such that the product better migrates to the dip tube opening; redesigning the pump mechanism such that it provides a greater amount of suction; and weighing down the end of the dip tube by a variety of methods such that the tube may better reach all of the contents of the container. For various reasons, including but not limited to functionality and cost, such prior art designs have not been able to adequately address the issue of wasted product. Accordingly, there exists a need for a new and improved device for retrieving the remaining product.

Accordingly, it is a general object of this disclosure to provide a cost effective and easy to use device for retrieving the remaining product left in a pump dispensing container.

It is another general object of the present disclosure to provide an apparatus for removing the remaining product left in a pump dispensing container that does not interfere with the regular suction process of the pump.

It is more specific object of the present disclosure to provide a device for removing the remaining product left in a pump dispensing container that can be used with any shape container.

It is another more specific object of the present disclosure to provide a device for removing the remaining product left in a pump dispensing container that can be used with any pump mechanism.

These and other objects, features and advantages of this disclosure will be clearly understood through a consideration of the following detailed description.

### SUMMARY OF THE INVENTION

According to an embodiment of the present disclosure, there is provided a dip tube for use with a pump dispenser having a tube portion with one end coupled to the pump mechanism, a longitudinal body and a distal end, the distal end having an extension portion having a generally flat top surface for removing residual product from the container.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is an elevational side view of a full lotion container and prior art dip tube.

FIG. 2 is an elevational side view of a pump exhausted lotion container and dip tube of FIG. 1.

FIG. 3 is a side view of lotion container dip tube according to the principles of an embodiment of the present disclosure.

FIG. 4 is an elevational side view of a full lotion container and the dip tube of FIG. 3.

FIG. 5 is an elevational side view of a pump exhausted lotion container and dip tube of FIG. 4.

FIG. 6 is a top cross-sectional view of the pump exhausted lotion container and dip tube taken along lines 6-6 of FIG. 5.

FIG. 7 is a side view of the lotion container dip tube of FIG. 3 with product thereon.

FIG. 8 is top view of the container and dip tube of FIG. 6 with a portion of product removed.

FIG. 9 is a top view of the container and dip tube of FIG. 6 with all of the product removed.

FIG. 10 is an enlarged elevated side view of the extension portion of the dip tube according to the principles of the present disclosure.

### DESCRIPTION OF THE PREFERRED EMBODIMENTS

One or more embodiments of the subject disclosure will now be described with the aid of numerous drawings. Unless otherwise indicated, use of the term “container” will be understood to include a bottle and any other type of package for holding product. Similarly, use of the term “product” will be understood to include, but not be limited to, lotions and the like.

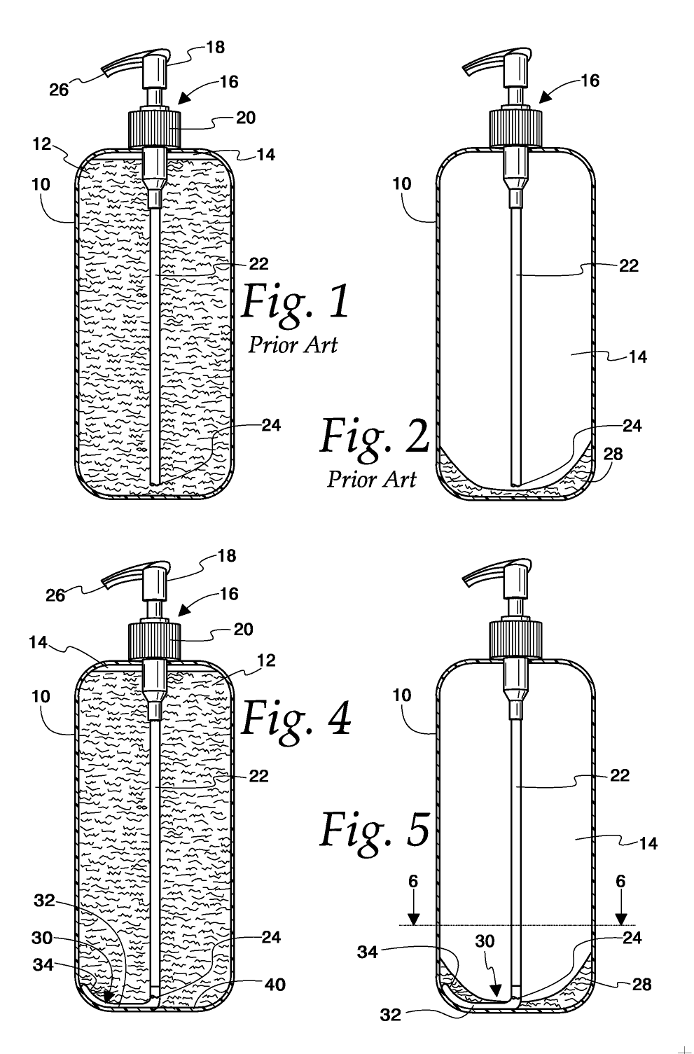

In any event, turning now to the Figures, and in particular FIG. 1, a container 10 is shown having a full amount of lotion 12 and minimal empty space 14. The prior art pump mechanism 16 includes a pump head 18, cap 20, and a dip tube 22 with a distal end 24. During use, the pump head 18 is depressed and lotion enters the distal end 24, travels through the tube 22 and exits the mouth 26 of the pump head 18. As FIG. 2 illustrates, when the pump mechanism is no longer able to suction the product up the dip tube, it has lost is functionality and there inevitably remains product residue 28 within the container 10. This is due to the fact that the distal end 24 of the prior art dip tube 22 cannot reach the remaining product and accordingly there is no longer the necessary suction for the pump mechanism 16 to effectively operate.

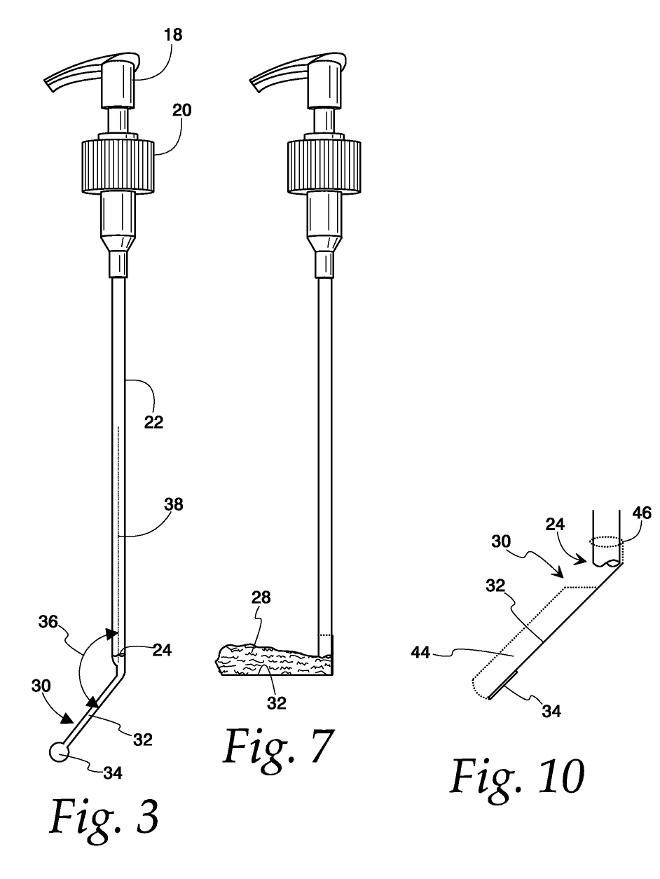

FIG. 3 is illustrative of the pump mechanism according to the principles of the present disclosure. Specifically, while it includes pump head 18, cap 20 and dip tube 22, it further includes an extension 30 portion extending from the distal end 24. The extension 30 has a generally flat top surface 32 and may also include a flange 34. The extension is preferably made of the same material as the dip tube 22 and when outside of a container is angled 36 from the longitudinal axis 38 of the dip tube 22. When the dip tube 22 is inserted into a container, the extension 30 bends and lays flat along the bottom of the container.

In FIG. 4, a container 10 is shown having a full amount of lotion 12 and a minimal empty space 14. The pump mechanism includes a pump head 18, cap 20 and a dip tube 22 with a distal end 24 and an extension 30 lying on the bottom 40 of the container 10. During use, the pump head 18 is depressed and lotion enters the distal end 24, travels up the dip tube 22 and exits the mouth 26 of the pump head 18. The extension 30 does not interfere with this process. As FIG. 5 illustrates, when the pump mechanism is no longer able to suction the product up the dip tube, it has lost its functionality and there inevitably remains product residue within the container 10.

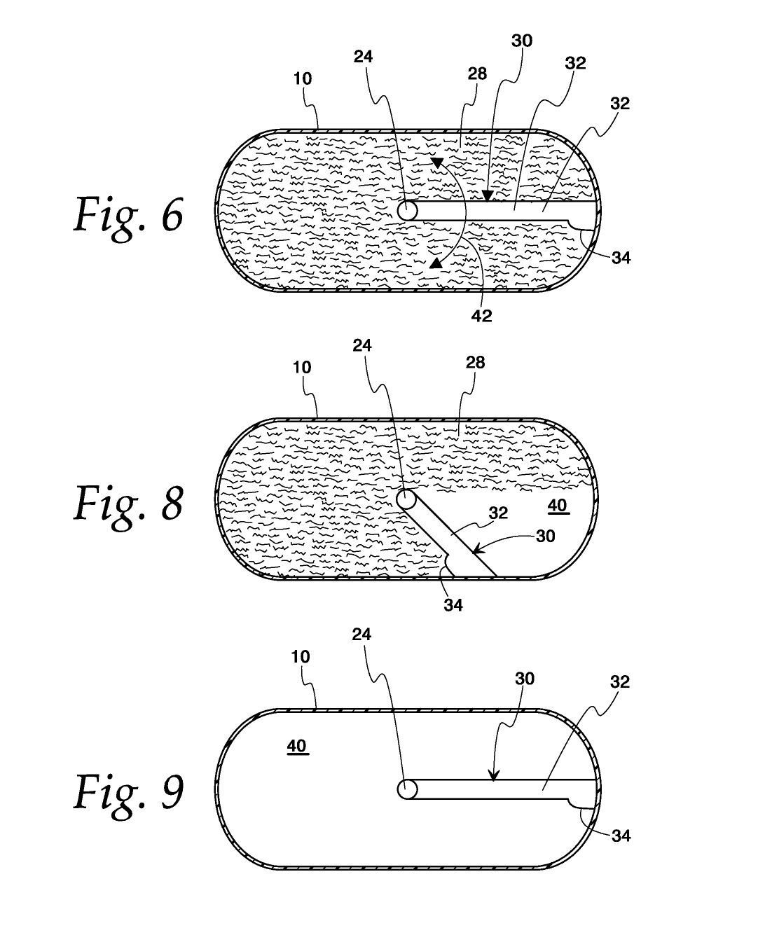

The remaining product can be best seen via the cross-sectional top view of FIG. 6. In particular, the remaining product 28 is shown on the bottom of the container 10, together with the distal end 24 of the dip tube and the extension 30 including top flat surface 32 and flanges 34. In order to obtain the remaining product, the user unscrews the cap from the bottle, rotates 42 the mechanism, and removes the tube from the container. FIG. 7 shows the removed tube of FIG. 3 with an amount of remaining product 28 from the container on the flat surface 32 thereof. The product can then be used and the tube reinserted into the container. FIG. 8 is illustrative of a clockwise rotation of the dip tube in order to acquire some of the remaining product. The extension clears the product and the bottom 40 of the container 10 is revealed. The user continues to rotate, remove the tube and use the product thereon until all of the remaining residual product has been cleared from the container and the bottom 40 of the container 10 is clear as shown in FIG. 9.

The enlarged side view of FIG. 10 illustrates an alternate embodiment of the extension. In particular, while the extension 30 includes the flat top surface 32 and optional flange(s) 34, it may further include side wall 44 on one or both sides of the flat top surface 32. This side wall aids in keeping the residual product 28 on the extension during rotation 42 as described above.

The extension is able to reach every corner and all sides of the bottom on the bottle easily. Unlike the prior art dip tube that can't reach once the pump top is unscrewed and removed from the bottle enough to try to see where the remaining product is located. The dip tube extension is preferably all one piece and preferably cut from existing dip tube material. However, the extension may also be attached to an existing dip tube via band 46 or other attachment mechanism. In any event, the extension while more flexible is still sturdy enough to function effectively as a scoop.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A pump dispenser with a dip tube for dispensing product from a container, wherein the dip tube comprises:
a tube portion having one end coupled to a pump mechanism, a longitudinal body and a distal end; and
an extension portion coupled to said distal end and having a generally flat top surface for removing residual product from said container.

2. The dip tube as defined in claim 1 wherein said extension portion includes a flange.

3. The dip tube as defined in claim 1 wherein said extension portion includes a side wall.

4. The dip tube as defined in claim 1 wherein said extension portion is biased at an angle greater than ninety degrees from a longitudinal axis of said tube portion.

5. A pump dispenser for dispensing product from a container with a dip tube having a tube portion having one end coupled to a pump mechanism, a longitudinal body and a distal end, wherein the dip tube comprises:
an extension portion detachably coupled to said distal end and having a generally flat top surface for removing residual product from said container.

6. The dip tube as defined in claim 5 wherein said extension portion includes a side wall.

7. The dip tube as defined in claim 5 wherein said extension portion is biased at an angle greater than ninety degrees from a longitudinal axis of said tube portion.
